(19) United States
(12) Patent Application Publication
(10) Pub. No.: US 2016/0098555 A1
(43) Pub. Date: Apr. 7, 2016

(54) PROGRAM CODE ATTESTATION CIRCUITRY, A DATA PROCESSING APPARATUS INCLUDING SUCH PROGRAM CODE ATTESTATION CIRCUITRY AND A PROGRAM ATTESTATION METHOD

(71) Applicant: ARM LIMITED, Cambridge (GB)

(72) Inventors: John David MERSH, Bottisham (GB); Stuart David BILES, Bury St. Edmunds (GB)

(21) Appl. No.: 14/504,815

(22) Filed: Oct. 2, 2014

(51) Int. Cl. G06F 21/51; H04L 9/32; G06F 21/57

(52) U.S. Cl. CPC G06F 21/51; G06F 21/575; H04L 9/3247; H04L 9/3236; G06F 2221/033

(57) ABSTRACT

Program code attestation circuitry and a method of operating such circuitry are provided. The program code attestation circuitry includes first storage, and measurement value generation circuitry that is arranged to store within that first storage a measurement value that is determined by applying a first hash algorithm to input data determined from a code block of the program code. Within a second storage a private key is stored. Further, signature generator circuitry is responsive to an attestation request from a request source external to the program code attestation circuitry to apply, to a derived value derived from the measurement value, a signature algorithm using the private key, in order to generate a signature for output to the request source. From this signature, the request source can then derive information about the stored measurement value sufficient to enable it to ascertain whether that stored measurement value agrees with an expected measurement value for the code block in question. This provides a simple and secure mechanism for attesting as to the correctness of code blocks of program code within a data processing apparatus.

### BACKGROUND

1. Technical Field

The present technique relates to program code attestation circuitry, a data processing apparatus including such program code attestation circuitry and a program code attestation method.

2. Description of the Prior Art

There are various situations where it is desirable to be able to attest as to the correctness of particular code blocks of program code to be executed on a data processing apparatus. For example, during a boot operation performed on a device, it is typically the case that the first item that executes is the boot ROM, which is immutable. Execution of the boot ROM will typically cause a series of code modules to be executed, and it is useful to be able to check that each of those code modules is as expected, i.e. has not been tampered with. It is known to perform various checks on such code modules in software as they are loaded during the boot process. However, such software checks are vulnerable to modification/circumvention, and accordingly it may be possible for a bug to be introduced into the boot chain that would enable a particular code module to be modified or replaced, hence compromising the security of the device.

As another example of a situation where it is desirable to check the correctness of code, it is possible for malware to be introduced into the device after boot time, and accordingly it would be desirable to provide a mechanism that allowed the correctness of code portions to be checked after boot time.

Accordingly, it is desirable to provide an improved mechanism for attesting to the correctness of code blocks of program code within a data processing system.

### SUMMARY

Viewed from a first aspect, there is provided program code attestation circuitry, comprising: a first storage; measurement value generation circuitry to store in said first storage a measurement value determined by applying a first hash algorithm to input data determined from a code block of program code; a second storage to store a private key; and signature generator circuitry, responsive to an attestation request from a request source external to the program code attestation circuitry, to apply, to a derived value derived from the measurement value, a signature algorithm using the private key, in order to generate a signature for output to the request source.

Viewed from a second aspect, there is provided a data processing apparatus comprising: program code attestation circuitry in accordance with the first aspect; and a request source to issue an attestation request to the program attestation circuitry, and to analyse the signature returned from the program attestation circuitry in response to said attestation request.

Viewed from a third aspect, there is provided a method of operating program code attestation circuitry, comprising: applying a first hash algorithm to input data determined from a code block of program code in order to generate a measurement value; storing the measurement value in a first storage of the program code attestation circuitry; storing a private key in a second storage of the program code attestation circuitry; and responsive to an attestation request from a request source external to the program code attestation circuitry, applying, to a derived value derived from the measurement value, a signature algorithm using the private key, in order to generate a signature for output to the request source.

Viewed from a fourth aspect, there is provided program code attestation circuitry, comprising: first storage means; measurement value generation means for storing in said first storage means a measurement value determined by applying a first hash algorithm to input data determined from a code block of program code; a second storage means for storing a private key; and signature generator means, responsive to an attestation request from a request source external to the program code attestation circuitry, for applying, to a derived value derived from the measurement value, a signature algorithm using the private key, in order to generate a signature for output to the request source.

### BRIEF DESCRIPTION OF THE DRAWINGS

The present technique will be described further, by way of example only, with reference to embodiments thereof as illustrated in the accompanying drawings, in which:

FIG. 1 is a diagram of a data processing apparatus in accordance with one embodiment;

FIG. 2 is a block diagram illustrating in more detail the attestation unit of FIG. 1 in accordance with one embodiment;

FIG. 3 is a flow diagram illustrating the operation of the measurement value generation circuitry of FIG. 2 in accordance with one embodiment;

FIG. 4 is a flow diagram illustrating the operation of the signature generator block of FIG. 2 in accordance with one embodiment;

FIG. 5 is a flow diagram illustrating the sequence of steps that may be initiated by a loader program executing on the CPU in one embodiment in order to perform attestation of a desired code block;

FIG. 6 is a flow diagram illustrating the operation of the loader program and the attestation unit in accordance with an alternative embodiment;

FIG. 7 is a diagram of a data processing apparatus in accordance with an alternative embodiment;

FIG. 8 is a block diagram illustrating in more detail the address range checker of FIG. 7 in accordance with one embodiment; and

FIG. 9 is a flow diagram illustrating an optional step that can be performed by the boot loader program in order to configure the address range checking hardware of FIG. 7 in accordance with one embodiment.

### DESCRIPTION OF EMBODIMENTS

Before discussing the embodiments with reference to the accompanying figures, the following description of embodiments and associated advantages is provided.

In accordance with one embodiment, a hardware module is provided in the form of program code attestation circuitry which, based on input data determined from a code block of program code, is arranged to apply a first hash algorithm in order to produce a measurement value for storing within a storage internal to the code attestation circuitry. Within a second storage within the program code attestation circuitry a private key is stored. Then, when an attestation request is received from a request source external to the program code attestation circuitry, signature generator circuitry within the program code attestation circuitry applies a signature algorithm using the private key to a value that is derived from the measurement value, in order to generate a signature. That signature is then output to the request source, and then can be used by the request source to detect whether the code block is correct, i.e. is as expected.

By the above approach, a secure mechanism can be provided for generating a measurement value indicative of a code block in question, and then providing a signature generated using a private key held internally within the program code attestation circuitry, from which a request source can derive an indication of that measurement value, and hence ascertain the correctness of the code block.

In one embodiment, the attestation request specifies a use once value, and the signature generator circuitry includes derived value generator circuitry to apply a second hash algorithm using the stored measurement value and the use once value, in order to generate the derived value. As a result, the signature generated by the program code attestation circuitry for a particular code block will vary each time an attestation request is received in relation to that code block, hence preventing an attacker from seeking to replicate the signature generation activities of the attestation circuitry and circumvent the functionality of the program code attestation circuitry. This hence increases the robustness and security of the mechanism.

In one embodiment, the stored measurement value is not used directly when applying the second hash algorithm, but instead the stored measurement value is first compared with the expected measurement value to produce a pass/fail indication which is then used to generate the derived value.

The use once value (also referred to as a nonce) can be generated in a variety of ways, provided that each time the attestation request is issued, a new use once value is generated in association with that attestation request. However, in one embodiment the use once value is a pseudo random value. In one particular embodiment, the request source has access to a pseudo random number generator for generating the use once value to be used in association with each attestation request.

There are a number of ways in which the use once value can be used in combination with the stored measurement value when applying the second hash algorithm. In one embodiment, the use once value is logically combined with the stored measurement value in order to form the input to the second hash algorithm. There are a number of ways in which the use once value may be logically combined with the stored measurement value. In one particular embodiment, the use once value is appended to the stored measurement value in order to form the input to the second hash algorithm.

It is important to maintain the privacy of the private key stored in the second storage of the program code attestation circuitry. In one embodiment this is achieved by ensuring, post manufacture, that the second storage is not accessible from external to the program code attestation circuitry. In one particular embodiment, the second storage is a write once storage. In accordance with such an embodiment, the private key is created and programmed into the second storage at manufacture time of the device that incorporates the program code attestation circuitry. This ensures that the private key cannot be tampered with post manufacture, and also prevents the private key from being copied and used to sign unofficial code.

The measurement value generation circuitry can be configured to operate in a variety of ways. However, in one embodiment the input data determined from a code block of program code is provided as a series of input data items, and the measurement value generation circuitry is responsive to each input data item to apply the first hash algorithm using the measurement value stored in the first storage and the input data item in order to generate an updated measurement value for storing in the first storage. Accordingly, by such an approach, the generation of the measurement value is an iterative process, with the measurement value being updated each time a new item of input data is received. The series of input data items can take a variety of forms, but in one example a separate item of input data can be provided for each line of code within the code block, for example by capturing at least a portion of the instruction contained within each line of the code block.

The first and second hash algorithms can take a variety of forms. In one embodiment, the two hash algorithms are the same. A variety of different hash algorithms can be used, but in one particular embodiment the hash algorithms are cryptographic hash algorithms such as SHA1 or SHA256.

In one embodiment the program code attestation circuitry is provided within a data processing apparatus that also includes a request source to issue an attestation request to the program attestation circuitry, and to analyse the signature returned from the program attestation circuitry in response to said attestation request.

There are a number of ways in which the request source can analyse the signature returned from the program code attestation circuitry. In one embodiment, the request source performs a comparison process to determine from the signature whether the stored measurement value matches an expected measurement value for the code block.

In one embodiment, the expected measurement value is determined at a time the code block is created, and accordingly if the code is modified in any way it is likely that the measurement value as generated by the program code attestation circuitry will differ from the expected measurement value. In one embodiment the expected measurement value will itself be signed using the private key in order to produce a signature that can be used to certify that the expected measurement value is indeed the one created at the time the code block was created.

Where the attestation request specifies a use once value, and the derived value that is subjected to the signature algorithm is hence based not only on the measurement value but also the use once value, then in one embodiment the comparison process performed by the request source can be arranged to generate an expected derived value by applying the second hash algorithm using the expected measurement value and the use once value. In particular, the use once value can be logically combined with the expected measurement value in the same way as the use once value is logically combined with the actual measurement value stored within the program code attestation circuitry.

In one embodiment, the signature received from the program code attestation circuitry is analysed by the request source in order to determine the derived value. In particular, in one embodiment the comparison process further comprises using a certificate associated with the private key to extract from the signature the derived value that was derived from the stored measurement value, and comparing the extracted derived value with the generated expected derived value. The certificate can take a variety of forms, but in one example is a certificate containing the public key paired with the private key owned by the device manufacturer and signed by a certification authority.

By performing the above comparison process, it can be detected whether the measurement value generated and maintained within the program code attestation circuitry matches the expected measurement value, and accordingly whether the code block being analysed is as expected. Assuming it is, then that code block will typically be allowed to be executed within the data processing apparatus, whereas if not a fault indication can be raised, to allow further action to be taken. For example, the raising of a fault indication may cause the program code in question to be quarantined and not executed, such that it can be subjected to some further analysis before deciding whether the code should be allowed to be run or not. For example, control software that is part of the program loader routine can then take a number of actions, including halting the system in an error condition, reinstating the program code in question from an alternative source, prompting the user for input, etc.

The request source can take a variety of forms, but in one embodiment comprises a processing unit executing a boot loader program. During execution of the boot loader program, a series of code modules will typically be ‘loaded’ for execution, and the above described process can be used to attest as to the correctness of those individual code modules before they are allowed to be executed. Whilst the ‘loading’ operation may involve physically copying the code into an internal memory of the device, such a step will not always be taken and the loading may instead merely perform some basic set-up steps required before the code module can be allowed to be executed.

In one such embodiment, the code block hence identifies a code module loaded by the boot loader program during the boot process. The above described process can then be repeated in turn for each of the code modules loaded during the boot loading operation. In one embodiment, a separate measurement value may be maintained for each separate code module, whilst in an alternative embodiment an accumulated measurement value may be generated during the loading operation performed in respect of a plurality of code modules.

Whilst in one embodiment the above described attestation mechanism is implemented during boot time, it is also possible to implement the attestation mechanism at any other desired point during the operation of the data processing apparatus. For example, in one embodiment the attestation request may itself identify the code block, and may trigger the measurement value generation circuitry within the program code attestation circuitry to determine the measurement value for that code block. By such an approach, the creation of the measurement value and the triggering of the attestation process can take place at any desired time during execution of code on the data processing apparatus, in order to attest to the correctness of any desired portion of the code.

There are a number of ways in which the attestation request may identify the code block. In one embodiment, it does so by specifying an address range for the code block to be analysed. The program code attestation circuitry may in one such embodiment then access memory in order to retrieve the required input data necessary to generate the measurement value, or alternatively the request source may trigger that activity, in order to cause the required input data to be provided to the measurement value generation circuitry.

In accordance with a further embodiment, an additional hardware checking mechanism is provided that can supplement the attestation mechanism already described. In particular, it has been realised that there can still be vulnerabilities in code blocks, even when those code blocks are the code blocks that were intended to be run. Sometimes those vulnerabilities can be exploited to cause the program to branch to memory addresses outside of the range of memory addresses attested to by the above attestation mechanism, which can compromise the security of the device.

To inhibit such activity, the data processing apparatus of one embodiment further comprises address checking circuitry to check that instructions fetched for execution reside within a memory address range of a code block that has been determined by the request source to be correct based on the signature provided by the signature generator circuitry.

In one embodiment the address checking circuitry comprises at least one address checking block that is programmable to identify the memory address range of a code block that has been determined by the request source to be correct. In one particular embodiment, the request source is arranged to program the memory address range of a code block into the at least one address checking block once it has determined that the code block is correct.

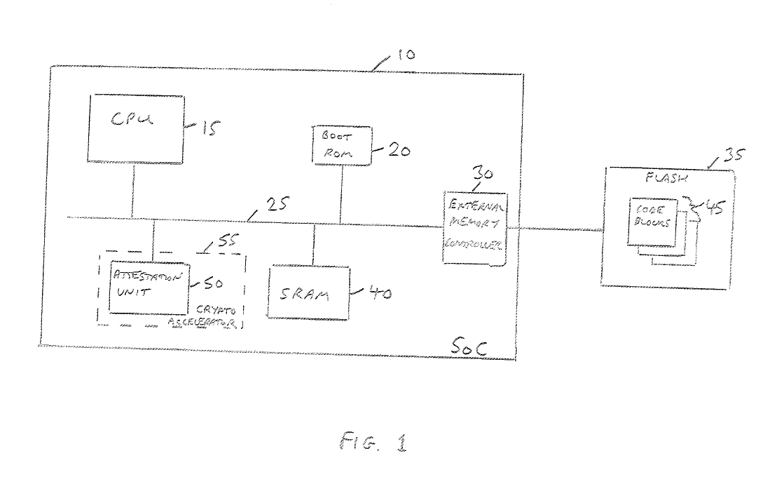

Particular embodiments will now be described with reference to the figures. FIG. 1 is a block diagram of a data processing apparatus in accordance with one embodiment. In particular, in this embodiment the data processing apparatus takes the form of a System-on-Chip (SoC) 10 consisting of a central processing unit (CPU) 15 connected via an internal bus network 25 with an internal memory 40 (in this example an SRAM memory) and a boot ROM 20 containing some initial boot code executed when the SoC 10 is booted, the contents of the boot ROM 20 being immutable. The SoC 10 may also be connected via an external memory controller 30 with some external devices, such as a flash memory device 35 containing a plurality of code blocks 45.

When the SoC is initially booted, the CPU 15 will execute some initial code stored in the boot ROM 20, which will in turn cause a series of code blocks 45 to be loaded and subsequently executed in order to complete the boot sequence. In one embodiment, the CPU 15 will execute a boot loader program stored within the boot ROM 20 in order to load the various code blocks 45. During the loading operating, in one embodiment each code block will be loaded into the SRAM 40 for execution.

During the process of loading each of the code blocks and executing those code blocks during the boot process, it is desirable to be able to attest as to the correctness of those code blocks, in order to ensure that none of the code blocks have been tampered with or replaced, which would compromise the security of the boot process and potentially allow security of the operations performed on the SoC 10 to be compromised. In one embodiment, the process of attesting as to the correctness of the various code blocks is performed with the assistance of a hardware module 50 connected to the bus network 25, this hardware module also being referred to herein as an attestation unit. Whilst the attestation unit 50 could be a stand-alone hardware module, in one embodiment its function can be incorporated within an existing cryptographic accelerator 55 provided within the SoC 10. In particular, a cryptographic accelerator 55 will typically include certain hardware data paths that could be used by the attestation unit in order to perform the required function of that attestation unit.

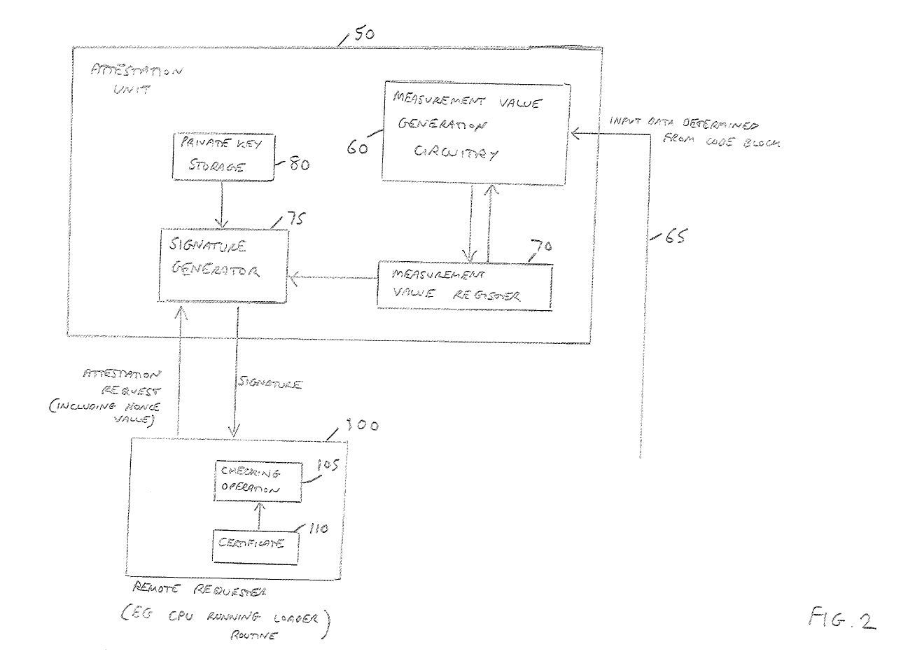

The operation of the attestation unit 50 will be described in more detail with reference to FIG. 2. As shown in FIG. 2, the attestation unit 50 includes measurement value generation circuitry 60 which is arranged to maintain a measurement value within a measurement value register 70. In one embodiment, prior to analysing a particular code block, the measurement value may be initialised to 0 within the measurement value register 70. Thereafter, as the loader program loads a particular code block prior to execution, it can read predetermined portions of the program code in order to provide a series of input data items over path 65 to the measurement value generation circuitry 60. For example, it may read the program code from each memory address within the code block or a predetermined portion of the program code at each memory address, for example the first byte, and as each line is read can input the read input data items to the measurement value generation circuitry 60. The measurement value generation circuitry is then arranged to perform a hash algorithm in respect of each item of input data received over path 65. In particular, the measurement value generation circuitry can be arranged to perform the following calculation:

measurement value=H(previous measurement value, input data item)

where

previous measurement value is the previous stored measurement value,

input data item is the supplied data item over path 65, and

H( ) is a cryptographic hash algorithm such as SHA1 or SHA256.

The “previous measurement value” may be initialised to a starting value prior to the hash algorithm being applied to the first item of input data. Any suitable logical combination of the data item with the previous measurement value may be performed in order to generate an input value for the hash algorithm. In one example embodiment, the input data item is merely appended to the previous measurement value stored in the register 70 prior to performing the hash algorithm in order to generate the updated measurement value. The updated measurement value generated by the above application of the hash algorithm is then stored back into the measurement value register 70. This process is then repeated iteratively for each input data item, until all of the input data items associated with the code block have been received and processed.

The effect of this approach is that the maintained measurement value in the register value 70 is dependent not only on every input data item received, but also the order in which those input data items are received. As will be discussed in more detail later, such a measurement value can also be produced when the code portion is originally written, with that measurement value forming an expected measurement value which can be stored within the system, for example stored in associated with each of the code blocks 45 within the flash memory device 35. In one embodiment, to inhibit tampering with the expected measurement value, each such expected measurement value is signed in some way in order to certify that it is the expected measurement value as originally generated at the time the code was created. In one embodiment, such a signature can be applied using the same private key as is stored within the private key storage 80. The manner in which the measurement value maintained within the attestation unit 50 can be compared with the expected measurement value in accordance with one embodiment will now be discussed in more detail with reference to the operation of the signature generator 75 provided within the attestation unit 50 of FIG. 2.

In particular, as shown in FIG. 2, a private key storage 80 is provided in which the private key is stored. Typically the private key storage 80 is a non-volatile write once storage which is inaccessible to anything external to the attestation unit 50 post manufacture. In one embodiment, at the time the SoC device is manufactured, the private key is stored within the private key storage 80, and due to the non-volatile write once nature of the storage cannot thereafter be tampered with. In an alternative embodiment, a mechanism could be provided to allow for a writeable private key post manufacture, for example by relying on some root of trust (i.e. an unmodifiable key) burnt into the SoC that only the entity with the permission to write the private key knows about.

The attestation unit 50, and in particular the signature generator 75, is then responsive to receipt of an attestation request from a remote requester 100 to apply a signature algorithm to generate a signature based on the measurement value stored within the register 70, the signature algorithm using the private key stored in the private key storage 80. To improve the robustness of the system, and in particular to prevent recreating of signatures by an attacker, in one embodiment each attestation request is accompanied by a use once value (herein referred to as a nonce value). Accordingly, upon receipt of the attestation request, in one embodiment the signature generator 75 is arranged to perform the following calculation:

signature=SIGN(H(value, nonce))

where

SIGN( ) is the asymmetric signature algorithm using the private key,

H( ) is a cryptographic hash algorithm,

value is the current measurement value,

nonce is the nonce supplied by the caller, and

signature is the resulting signature to return to the remote requester.

As shown in FIG. 2, this generated signature is then returned to the remote requester 100 where it is used as an input to a checking operation 105 executed by the remote requester. As shown, the checking operation 105 has access to a certificate 110 which is associated with the private key stored in the private key storage 80. In particular, the certificate is one that was signed by a key owned by the device manufacturer, and which verifies the public part of the private key/public key pair. Using this information, it is possible for the checking operation to extract from the signature the hash value that was created from the measurement value and the nonce. This hash value will be referred to herein as a one time measurement value, since it will be appreciated that by incorporating the nonce into the hashing operation, the output from the hash function that is then subjected to the signature will vary each time the signature generator is required to generate a signature for the measurement value. Accordingly, this prevents any replay attack mechanism where an attacker tries to intercept an attestation request to the attestation unit, and replay the signature, rather than providing the remote requester with the signature generated by the attestation unit.

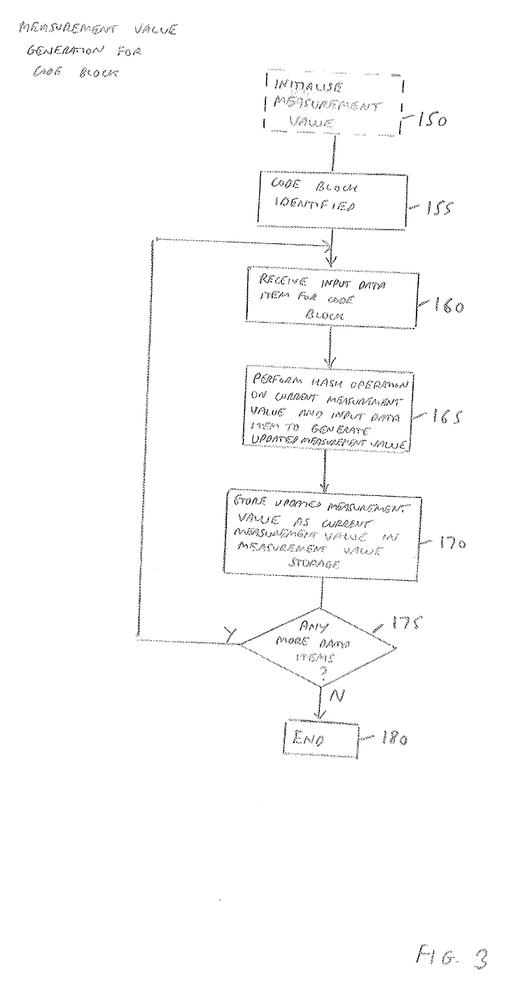

FIG. 3 is a flow diagram illustrating the operation of the measurement value generation circuitry 60 of FIG. 2 in accordance with one embodiment. At step 150, the measurement value stored in the register 70 is optionally initialised, for example by resetting the register to a 0 value. This can be performed each time a measurement value is to be accumulated for a particular code block. Alternatively, multiple code blocks may be subjected to the measurement value generation process without reinitialising the measurement value between each code block if that is desired. By not reinitialising the measurement value, this may help to build up a “chain” of trust where the modules loaded sequentially form a complete package of software that is dependent on the validity and version of each module loaded.

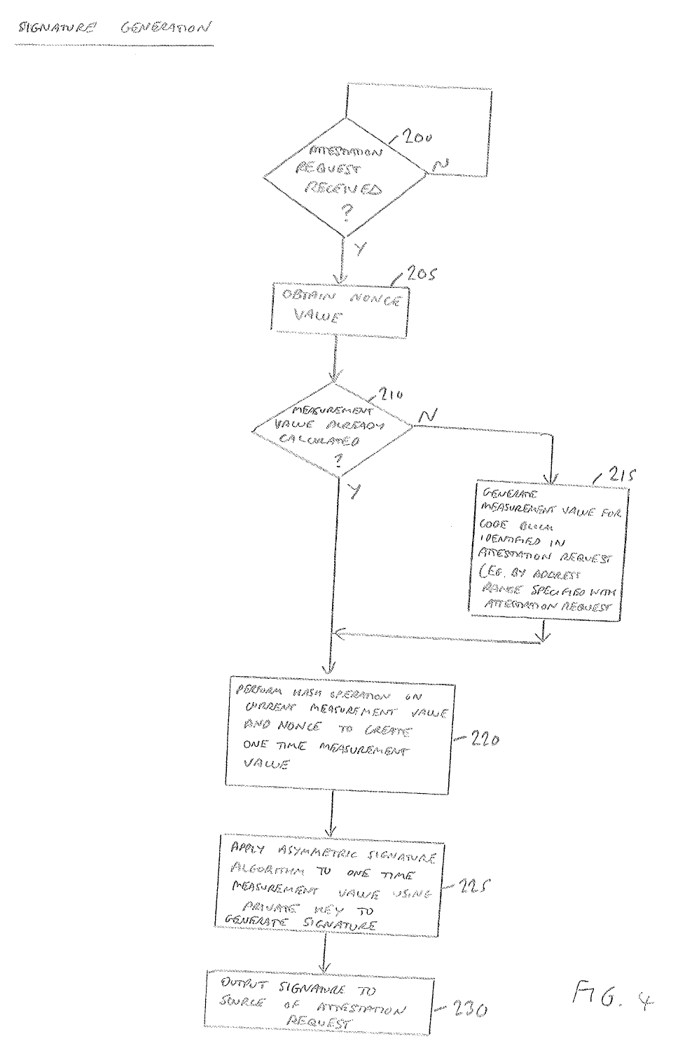

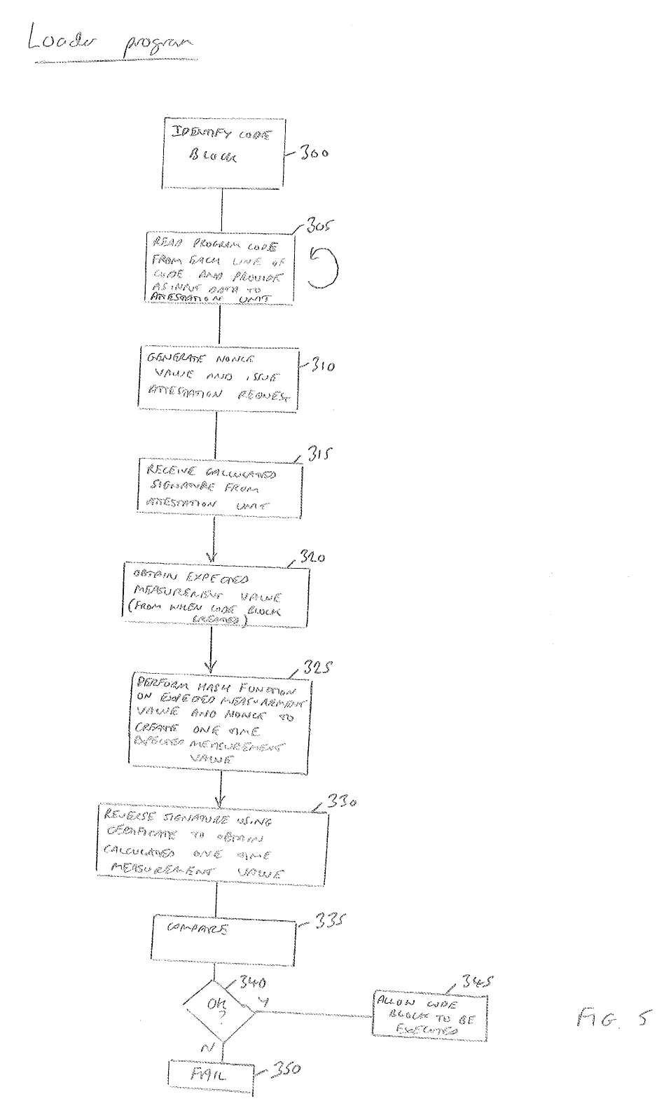

At step 155, the code block to be subjected to the attestation operation is identified, for example by the boot loader program running on a CPU during the boot processing. At step 160, the measurement value generation circuitry will receive an input data item for that identified code block. For example, the boot loader program may access each line of code in the code block, read a predetermined portion of the program code in that code line, and provide that as input data to the measurement value generation circuitry at step 160. At step 165, a hash operation is performed within the measurement value generation circuitry using the current measurement value obtained from the register 70 and the input data item in order to generate an updated measurement value which is then stored back into the register 70 at step 170. At step 175 it is determined whether there are any more data items to process, and if so steps 160, 165 and 170 are repeated for the next input data item. Once all of the input data items for the associated code block have been received and processed in the above manner, then the process ends at step 180. At this point, the measurement value stored in the register 70 should correlate with the expected measurement value generated at the time the code block was created, and any tampering with that code block will have resulted in the measurement value generated and stored within the attestation unit 50 not matching that expected measurement value. The manner in which the check between the measurement value created by the attestation unit 50 and the expected measurement value is performed in one embodiment will now be discussed with reference to FIGS. 4 and 5.

In particular, FIG. 4 illustrates the signature generation process performed by the signature generator 75 of the attestation unit 50 of FIG. 2. At step 200, the signature generator 75 awaits an attestation request from the remote requester 100. Once received, the nonce value is then obtained at step 205. As previously discussed, in one embodiment the nonce value is actually generated by the remote requester as part of the attestation request.

At step 210, it is determined whether the measurement value has already been calculated within the attestation unit 50. This will typically be the case when the code being analysed is a code module loaded by the boot loader during boot of the system. However, as mentioned earlier, in alternative embodiments it is possible to perform the code block attestation mechanism at any point during the execution of the software on the SoC. In particular, the remote requester 100 could at the time of issuing an attestation request also identify a code block to be analysed, for example by providing an a memory address range in association with the attestation request, the memory address range identifying the code block to be analysed. In that latter example, it will be determined at step 210 that the measurement value has not already been calculated, and instead the process will branch to step 215 where the measurement value generation unit 60 is used to generate a measurement value for the identified code block. This will involve performance of the earlier described process, but in one embodiment rather than the measurement value generation circuitry 60 passively receiving each input data item over path 65, it may be arranged instead to actively access each memory address identified by the memory address range accompanying the attestation request in order to read and retrieve the required input data items in order to generate the measurement value to be stored in the measurement value register 70.

Once step 215 has been performed, then the process proceeds to step 220. Alternatively, if at step 210 it is determined that the measurement value has already been generated, the process proceeds directly from step 210 to step 220.

At step 220, the signature generator 75 performs a hash operation using as inputs the measurement value from the register 70 and a nonce provided by the attestation request, in order to create a one time measurement value. In one embodiment this hash operation uses the same hash algorithm as used by the measurement value generation circuitry.

Thereafter, at step 225, an asymmetric signature algorithm is applied to the one time measurement value using the private key, in order to generate a signature. By using an asymmetric signature algorithm, it is then possible later to extract the one time measurement value from the signature by using the corresponding public key.

At step 230, the signature is output to the source of the attestation request.

FIG. 5 is a flow diagram illustrating a sequence of steps performed by a boot loader program forming part of the remote requester 100 in accordance with one embodiment. This diagram also explains one mechanism by which the signature output from the signature generator can be used to check whether the measurement value generated by the attestation unit 50 matches the expected measurement value, and hence whether the code block being analysed is considered to be as expected. At step 300, a code block is identified, and then at step 305 the program code is read from each line of the code block in order to provide a series of input data items to the attestation unit 50. This process is repeated iteratively for each of the lines of program code and, as will be apparent from the earlier discussion of the operation of the measurement generation circuitry 60, results in iterative update of the measurement value stored in the measurement value register 70. Once the process has completed, the measurement value stored in the register 70 should correspond with an expected measurement value, assuming that the code block has not been tampered with or replaced.

The step 305 of reading the program code from each line of the code block could be performed as part of a copying process performed by the boot loader where, in the example of FIG. 1, the code block is copied from the flash device 30 into the SRAM 40. Alternatively, the entire code block could be loaded first into the SRAM, and then an address range given to the attestation unit in order to enable the measurement value generation circuitry to access and obtain the required input data items to enable the measurement value to be generated.

As step 310, a nonce value is generated, e.g. with reference to a pseudo random number generator, and then is issued along with an attestation request to the attestation unit 50. As discussed earlier with reference to FIG. 4, this triggers the attestation unit 50 to generate a signature, which is then received at step 315.

At step 320, the expected measurement value as generated when the code block was created is obtained. This expected measurement value may be stored in a variety of locations, but in one embodiment is stored in association with each of the code blocks 45 in the flash device 35. Typically, the expected measurement value will be signed in order to produce a certificate verifying that the expected measurement value is the one that was produced at the time the code block was generated. With reference to the public key part of the private key/public key pair, the expected measurement value can then be extracted from the signature.

At step 325, the boot loader program will then perform a hash function on the expected measurement value using the same nonce that was provided to the attestation unit 50, in order to create a one time expected measurement value. When performing this hash function, the boot loader program also uses the same hash algorithm as used by the signature generator 75.

At step 330, the certificate identifying the public key is used to extract from the signature the calculated one time measurement value that was generated within the attestation unit 50 based on the measurement value stored in the storage 70 and the nonce value provided with the attestation request.

At this point, it will be appreciated that at step 335 the calculated one time measurement value can then be compared with the one time expected measurement value. At step 340, it can then be determined whether the code block is ok, i.e. whether the one time measurement values match, in which case at step 345 the code block can be allowed to be executed. However, if the comparison process at step 335 indicates that the one time measurement values do not match, then the process can proceed to step 350, where a fail condition is triggered. A number of steps can be taken in response to the fail condition, for example the code block could be quarantined and not allowed to be executed until further analysis steps have been performed.

Whilst FIG. 5 has been described with reference to the operation of a boot loader program executed during the performance of a boot process, as discussed earlier the attestation mechanism can be triggered at any point during operation of code on the SoC 10. In accordance with such an embodiment, a measurement value is not maintained as code is loaded, but instead when an attestation request is issued a memory range for the code block to be analysed is supplied. The attestation unit then reads from that range of memory addresses in order to obtain the required data inputs to the measurement value generation circuitry, and then performs the following calculation:

signature=SIGN(H(H(memory range), nonce))

where

SIGN( ) is the asymmetric signature algorithm using the private key,

H( ) is a cryptographic hash algorithm,

memory range is the memory range requested,

nonce is the nonce supplied by the requester, and

signature is the resulting signature to return to the requester.

As can be seen from the above calculation, the measurement value generation circuitry generates the measurement value by iteratively repeating the hash function using the addresses in the memory range, and then the signature generator hashes that measurement value in combination with the nonce value provided with the request, and then applies the asymmetric signature algorithm in order to generate the signature.

Steps 320 to 350 of FIG. 5 can then be performed by the remote requester in order to determine whether the code portion is as expected. The advantage of such an approach is that the measurement is made at the time of the request, and can be used to catch malware which may have been inserted after boot time.

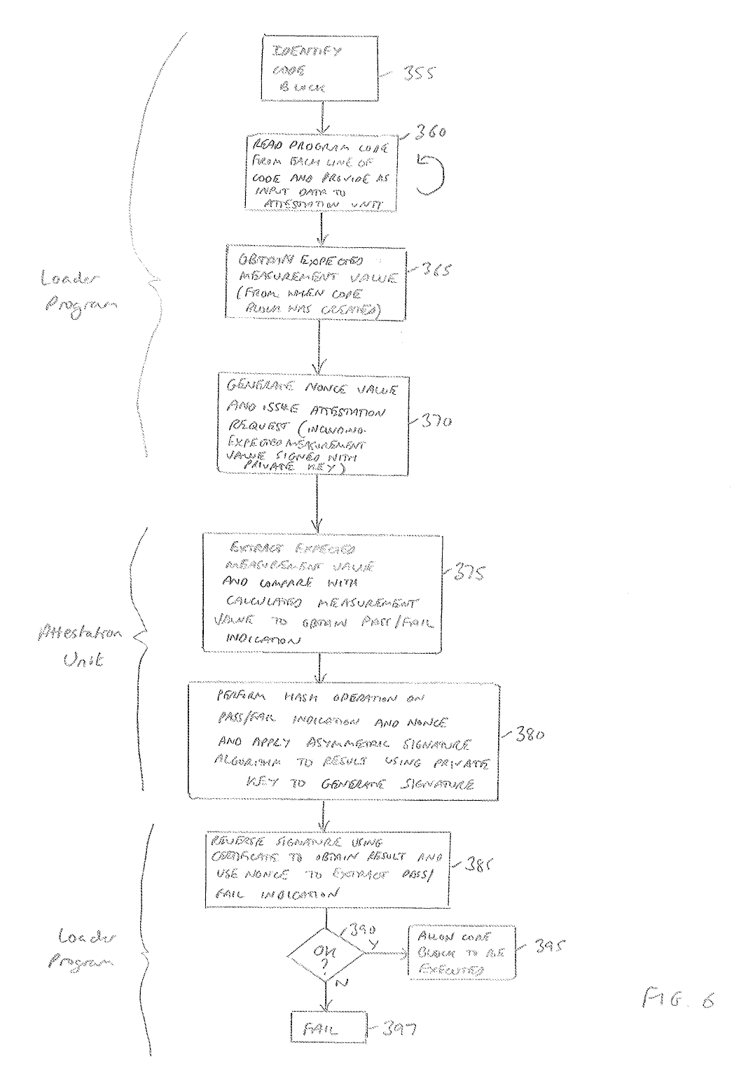

FIG. 6 illustrates the operation of the loader program and the attestation unit in accordance with an alternative embodiment. Steps 355 and 360 are identical to steps 300 and 305 of FIG. 5, and result in the attestation unit maintaining a calculated measurement value within the register 70. At step 365, the expected measurement value is obtained, as discussed earlier with reference to step 320 of FIG. 5. Thereafter, at step 370, a nonce value is generated and an attestation request is issued, in a similar way to that discussed earlier with reference to step 310 of FIG. 5. However, in this instance, the attestation request also includes the expected measurement value. In one embodiment, the expected measurement value is signed with the private key, and as mentioned earlier, in one embodiment the expected measurement value may already be stored in this form within the flash device 35, and hence can merely be included in that form with the attestation request.

Within the attestation unit, the expected measurement value is then extracted at step 375 (in this embodiment the attestation unit for example including a certificate identifying the public key of the public key/private key pair that can be used for this purpose). In addition, at step 375, the extracted expected measurement value is then compared with the calculated measurement value stored within the attestation unit in order to obtain a pass/fail indication.

Thereafter, at step 380, a hash operation is performed on the pass/fail indication and the nonce in order to produce a result to which the asymmetric signature algorithm is then applied using the private key in order to generate a signature for output from the attestation unit. In this embodiment, the result produced by performing a hash operation on the pass/fail indication and the nonce can be considered to be a derived value derived from the calculated measurement value, given that the pass/fail indication is itself derived from the calculated measurement value by comparison of the measurement value with the expected measurement value.

When the loader program receives the signature generated by the attestation unit, then at step 385 it reverses the signature using the certificate containing the public key in order to obtain the earlier mentioned result. Further, the nonce is then used to extract the pass/fail indication from that result. Thereafter, steps 390, 395 and 397 correspond with steps 340, 345 and 350 of FIG. 5.

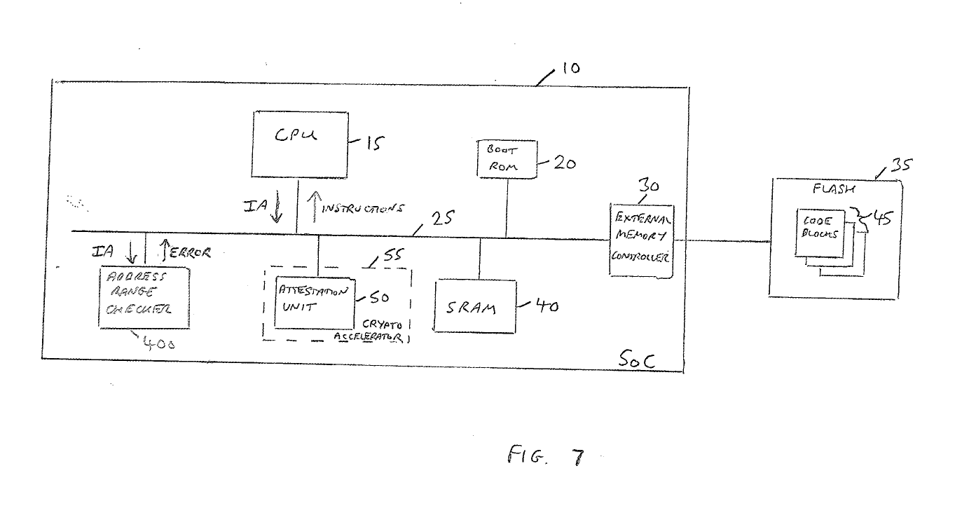

In accordance with a further embodiment as illustrated schematically in FIG. 7, an additional hardware checking mechanism is provided that can supplement the attestation mechanism already described. In particular, it has been realised that there can still be vulnerabilities in code blocks, even when those code blocks are the code blocks that were intended to be run. Sometimes those vulnerabilities can be exploited to cause the program to branch to memory addresses outside of the range of memory addresses attested to by the above attestation mechanism, which can compromise the security of the device.

Accordingly, as shown in FIG. 7, an address range checker circuit 400 can be provided, whose function is triggered after the above attestation mechanism has been used to verify that a code block to be executed by the CPU 15 is the original intended code block. In particular, at that point, the address range checker can be programmed with the memory address range of the code block that has been checked, so that any instructions within the memory address range are allowed to execute. However, any instruction from an address that is outside the memory address range of any code blocks that have been checked by the attestation unit 50 is prevented from being executed. Hence, when the CPU 15 issues an instruction address (IA) onto the bus 25 in order to retrieve an instruction for execution (for example by retrieving that instruction from the SRAM 40), that instruction address may also be provided to the address range checker 400, in order to check that that instruction address is actually within any memory address ranges that have been subjected to the attestation mechanism. Provided that the instruction address is within one of those ranges, the instruction is allowed to execute. However, if it is not, an error signal is issued by the address range checker 400. The error signal can be used in a variety of ways, but in one embodiment can be used to trigger an exception.

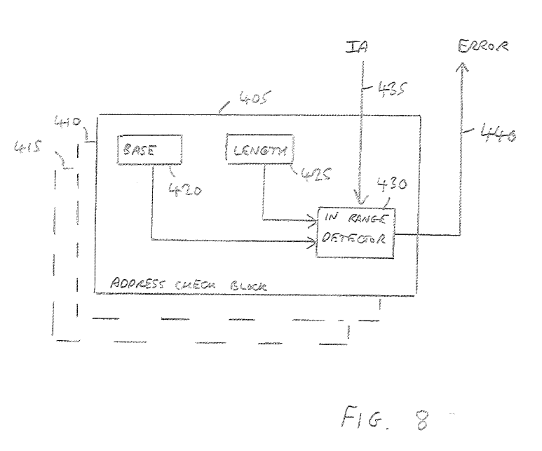

FIG. 8 illustrates an address check block that can be provided within the address range checker 400. In particular, the address check block 405 includes two registers 420, 425 that are used to store both a base address and a length identifying a particular memory address region containing a code block that has been successfully subjected to the earlier described attestation mechanism. An instruction address issued by the CPU 15 is passed over path 435 to the in range detector 430, which compares that instruction address with the base and length information stored in the registers 420, 425 in order to determine whether that instruction address is within that memory address range. If so, the error signal over path 440 is not asserted, but if the instruction address is outside of the range, an error signal is instead asserted.

In one embodiment, multiple such address check blocks may be provided, as shown by the elements 405, 410, 415 in FIG. 8. Each address check block will be associated with a different memory address range. In such embodiment, the error signal will only be asserted if the provided instruction address is not within any of the memory address ranges programmed into the various address check blocks.

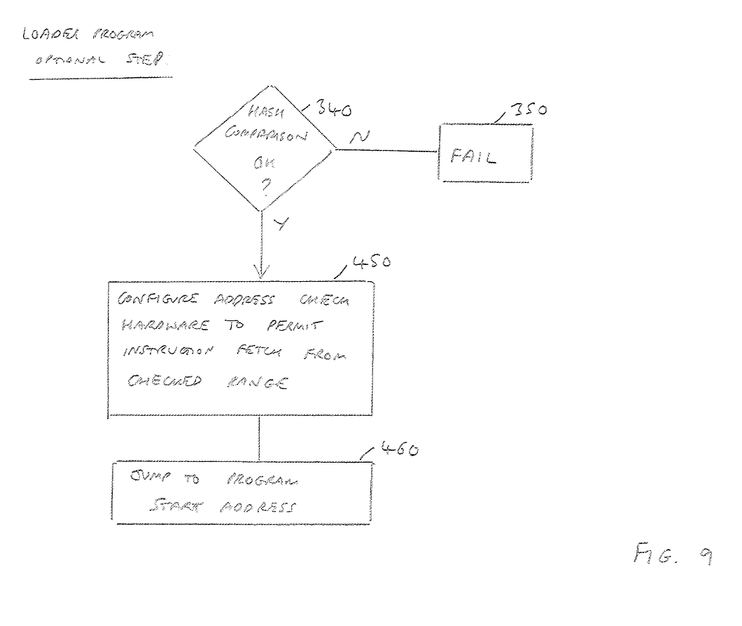

FIG. 9 is a flow diagram illustrating an optional step that may be taken by the boot loader program when utilising the address range checker 400 of FIG. 7. In particular, steps 340 and 350 correspond with the steps 340 and 350 at the end of FIG. 5, but steps 450 and 460 replace step 345 of FIG. 5. Hence, if the hash comparison check performed by the remote requester 100 identifies that the code block is as intended, then at step 450 the boot loader program can be arranged to configure the address check hardware 400, and in particular one of the address check blocks 405, 410, 415, to identify the base and length information for the memory address range associated with that code block, thereby permitting instruction fetches from that checked memory address range. Thereafter, at step 460, the boot loader program can jump to the program start address.

There are a number of other options that can be taken when using an address range checker 400 as described above. For multiple code blocks that occupy consecutive address ranges, the cumulative address range associated with those multiple code blocks can be programmed into a single address check block 405, 410, 415, in order to reduce the resources required within the address range checker.

Further, the checking functionality of the address range checker 400 can be arranged to be active only in certain modes of operation. For example, it may be arranged to be active when the CPU is in a user mode of operation, but may be deactivated in other more trusted modes, such as a privileged mode of operation.

As another option, certain address ranges in the address match may be considered to always be ok or not ok to load instructions from, with an address check block been programmed accordingly to identify any such ranges. It will be appreciated that for a “not ok” range, it is merely required that the in range detector 430 generates an error signal when an instruction address is within the programmed range, rather than when it is not.

Whilst in FIG. 7 the address range checker 400 is shown as a separate hardware block, its functionality could be incorporated within the attestation unit 50, or indeed could be constructed to be part of the functionality of the CPU or an associated MPU/MMU.

It will be appreciated that the above described embodiments provide a particularly simple and robust mechanism in hardware for attesting as to the correctness of code portions executed on a data processing apparatus, and optionally for further checking that those code portions attested as being correct actually function as expected.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

We claim:

1. Program code attestation circuitry, comprising:
a first storage;
measurement value generation circuitry to store in said first storage a measurement value determined by applying a first hash algorithm to input data determined from a code block of program code;
a second storage to store a private key; and
signature generator circuitry, responsive to an attestation request from a request source external to the program code attestation circuitry, to apply, to a derived value derived from the measurement value, a signature algorithm using the private key, in order to generate a signature for output to the request source.

2. Program code attestation circuitry as claimed in claim 1, wherein the attestation request specifies a use once value, and the signature generator circuitry includes derived value generator circuitry to apply a second hash algorithm using the stored measurement value and the use once value, in order to generate the derived value.

3. Program code attestation circuitry as claimed in claim 2, wherein the use once value is a pseudo random value.

4. Program code attestation circuitry as claimed in claim 2, wherein the use once value is logically combined with the stored measurement value in order to form the input to the second hash algorithm.

5. Program code attestation circuitry as claimed in claim 1, wherein, post manufacture, said second storage is not accessible from external to said program code attestation circuitry.

6. Program code attestation circuitry as claimed in claim 5, wherein said second storage is a write once storage.

7. Program code attestation circuitry as claimed in claim 1, wherein the input data determined from a code block of program code is provided as a series of input data items, and the measurement value generation circuitry is responsive to each input data item to apply the first hash algorithm using the measurement value stored in the first storage and the input data item in order to generate an updated measurement value for storing in the first storage.

8. Program code attestation circuitry as claimed in claim 2, wherein said second hash algorithm is the same as the first hash algorithm.

9. A data processing apparatus comprising:
program code attestation circuitry as claimed in claim 1; and
a request source to issue an attestation request to the program attestation circuitry, and to analyse the signature returned from the program attestation circuitry in response to said attestation request.

10. A data processing apparatus as claimed in claim 9, wherein said request source performs a comparison process to determine from the signature whether the stored measurement value matches an expected measurement value for the code block.

11. A data processing apparatus as claimed in claim 10, wherein the expected measurement value is determined at a time the code block is created.

12. A data processing apparatus as claimed in claim 10, wherein:
the attestation request specifies a use once value, and the signature generator circuitry within the program code attestation circuitry includes derived value generator circuitry to apply a second hash algorithm using the stored measurement value and the use once value, in order to generate the derived value; and
the comparison process includes generating an expected derived value by applying the second hash algorithm using the expected measurement value and the use once value.

13. A data processing apparatus as claimed in claim 12, wherein the comparison process further comprises using a certificate associated with the private key to extract from the signature the derived value that was derived from the stored measurement value, and comparing the extracted derived value with the generated expected derived value.

14. A data processing apparatus as claimed in claim 9, wherein the request source comprises a processing unit executing a boot loader program.

15. A data processing apparatus as claimed in claim 14, wherein the code block identifies a code module loaded by the boot loader program during a boot process.

16. A data processing apparatus as claimed in claim 9, wherein the attestation request identifies the code block, and triggers the measurement value generation circuitry to determine the measurement value for that code block by applying the first hash algorithm to input data determined from that code block.

17. A data processing apparatus as claimed in claim 16, wherein the attestation request specifies the code block by specifying an address range for that code block.

18. A data processing apparatus as claimed in claim 9, further comprising:
address checking circuitry to check that instructions fetched for execution reside within a memory address range of a code block that has been determined by the request source to be correct based on the signature provided by the signature generator circuitry.

19. A data processing apparatus as claimed in claim 18, wherein the address checking circuitry comprises at least one address checking block that is programmable to identify the memory address range of a code block that has been determined by the request source to be correct.

20. A data processing apparatus as claimed in claim 19, wherein the request source is arranged to program the memory address range of a code block into the at least one address checking block once it has determined that the code block is correct.

21. A method of operating program code attestation circuitry, comprising:
applying a first hash algorithm to input data determined from a code block of program code in order to generate a measurement value;
storing the measurement value in a first storage of the program code attestation circuitry;
storing a private key in a second storage of the program code attestation circuitry; and
responsive to an attestation request from a request source external to the program code attestation circuitry, applying, to a derived value derived from the measurement value, a signature algorithm using the private key, in order to generate a signature for output to the request source.

22. Program code attestation circuitry, comprising:
first storage means;
measurement value generation means for storing in said first storage means a measurement value determined by applying a first hash algorithm to input data determined from a code block of program code;
a second storage means for storing a private key; and
signature generator means, responsive to an attestation request from a request source external to the program code attestation circuitry, for applying, to a derived value derived from the measurement value, a signature algorithm using the private key, in order to generate a signature for output to the request source.
